(19) United States
(12) Patent Application Publication
(10) Pub. No.: US 2023/0329238 A1
(43) Pub. Date: Oct. 19, 2023

(54) METHOD FOR THE CONTROL OF INSECTS IN STORED PRODUCTS AND STRUCTURES

(71) Applicant: MURDOCH UNIVERSITY, Murdoch (AU)

(72) Inventors: Manjree Agarwal, Kardinya (AU); YongLin Ren, Kardinya (AU); Xin Du, Shelley (AU); Hamish McKirdy, Salter Point (AU)

(21) Appl. No.: 18/023,770

(22) PCT Filed: Aug. 19, 2021
(86) PCT No.: PCT/AU2021/050915

§ 371 Date: Feb. 28, 2023

(30) Foreign Application Priority Data
Sep. 1, 2020 (AU) 2020903118

(51) Int. Cl. A01N 59/00; A01N 25/06; A01P 7/04; A23B 9/30

(52) U.S. Cl. CPC A01N 59/00; A01N 25/06; A01P 7/04; A23B 9/30

(57) ABSTRACT

A method of killing insects on or around stored products or in structures, comprising the step of depositing or suspending in the air a composition comprising a mixture of hydrophilic synthetic amorphous silica (SAS) and hydrophobic SAS on or around the stored products or structure.

### FIELD OF THE INVENTION

The present invention relates to methods and compositions for controlling larvae, nymph and adult insect pests in stored products and structures using synthetic amorphous silicas.

### BACKGROUND TO THE INVENTION

Insect infestations can result in economic loss through food spoilage. One area where insect infestations are particularly problematic is in relation to stored products. Stored products such as grains and rice are particularly susceptible to insect infestations. The insects not only consume the stored products, but also reduce the quality of the products by contaminating them with insect fragments, faeces, webbing and metabolic products in addition to mould contamination. Approximately 300 insect species can infest stored products; however, only 18 are of primary economic importance. Beetles (Coleoptera) and moths (Lepidoptera) are the main insect pests that damage stored products. Some insect pests, like cockroaches, silverfish, ants and termites, spread in grain stores and cause off odour in food, particularly in wet places.

Whilst there are various insecticides available, many of these are not suitable for widespread application due to their toxicity. Furthermore, many insecticides tend to be active against a relatively narrow range of targets and only function optimally under very specific conditions of moisture, humidity and temperature. These factors, combined with the ever-increasing problem of insecticide resistance, means there is a need for new and effective insecticides, particularly insecticides that have reduced health safety issues.

Currently, fumigants are the most effective pesticides for managing stored-grain insects and avoiding the losses caused by insects. However, environmental and economic considerations have limited the number of chemicals that are available for application in the grain industry. Consequently, in recent years there has been a decline in the number of fumigants used to control stored grain pests, and only two fumigants, methyl bromide and phosphine, are currently available for use. Methyl bromide is being phased out after international signing of the Montreal Protocol on Substances that Deplete the Ozone Layer and excessive usage of phosphine has resulted in resistance problem against Rhyzopertha dominica, Tribolium castaneum and Cryptolestes species Many solid formulation insecticides designed for application to stored products, such as diatomaceous earth, are less than ideal because they need to be applied at relatively high doses and the food often requires treatment to remove the insecticide before it is safe for processing and/or consumption.

Insect infestations can also cause structural damage to houses, commercial buildings, bridges and other structures. Termites and ants are the major insect pests that cause structural damage, leading to economic costs and safety issues in compromised structures. Most of the damage can be attributed to the infestation of soil-dwelling species like subterranean termites, which are regarded as the main threat posed to timber in service or structural. Coptotermes acinaciformis is one of the species of subterranean termites most responsible for damage. About 40 species of ants are common structure-infesting pests in food outlets, including cafeterias, coffee shops, residential kitchens, hotel kitchens and dormitory pantries.

Control of termites and ants mainly relies on chemical insecticides. However, due to environmental pollution and public health concerns, alternative control measures are required. Since both termites and ants are social insects living in colonies, food baits have long been applied in management of household insect pests. There are patents on ant baits (EP2369919), but these baits can pose potential threats to pets and wild animals. In addition, it is often difficult to kill a termite or ant queen using baits.

Considering the control methods presently available, there is a need for more effective, safe and economical insecticides and methods for the treatment of stored products and structures, or at least commercial alternatives.

### SUMMARY OF THE INVENTION

The present invention provides a method of killing insects on or around stored products or in structures comprising the step of:
i. depositing or suspending in the air a composition comprising a mixture of hydrophilic synthetic amorphous silica (SAS) and hydrophobic SAS on or around the stored products or structure.

Preferably, the mixture of hydrophilic synthetic amorphous silica and hydrophobic synthetic amorphous silica is used in a ratio of hydrophilic SAS to hydrophobic SAS of between 99.9:0.1 and 0.1:99.9.

The present invention further provides a composition for use in a method of killing insects on or around stored products or in structures, wherein the composition comprises a mixture of hydrophilic synthetic amorphous silica (SAS) and hydrophobic SAS and wherein the composition is deposited or suspended in the air on or around the stored products or structure.

In another aspect, the present invention provides a kit for killing insects on or around stored products or in structures, wherein the kit comprises:
i. a composition comprising a mixture of hydrophilic synthetic amorphous silica (SAS) and hydrophobic SAS; and
ii. instructions for use
   wherein the composition is deposited or suspended in the air on or around the stored products or structure.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a graph of the efficacy of SAS formulations HP8:HB9 (99.9 to 0.1) at 0.5 g/m² for 10 mins exposure against various ants and termites.

FIG. 2 is a graph of the efficacy of SAS formulations HP8:HB9 (99.9 to 0.1) at 1 g/m² for 10 mins exposure against various ants and termites.

FIG. 3 diagrammatically describes the concept of transfer effect of dust from treated to untreated ants and finally to nest and how a single treated ant/termite can kill the whole colony including queen.

FIG. 4 is a graph of the efficacy of dust in transfer effect from treated to untreated Pavement ants.

FIG. 5 is a graph of the efficacy of dust in transfer effect from treated to untreated Subterranean termites.

FIG. 6 is a graph of the effect of ambient relative humidity on mortality of Tribolium castaneum treated with different ratios of HB9 to HP8.

FIG. 7 is a graph of the efficacy of HP, HB and HP+HB at different ratios for management of Tribolium castaneum at 25° C., 60-70% relative humidity when applied at 100 mg/kg of the commodity.

### DESCRIPTION OF INVENTION

### Detailed Description of the Invention

### Method for Killing Insects

Synthetic amorphous silica has been used as an agent for controlling insect pests in harvested and stored grains, as described in AU2015234233. However, the SAS administration of the prior art was either administration of hydrophilic SAS or hydrophobic SAS. The present invention has surprisingly found that applying a mixture of both hydrophilic SAS and hydrophobic SAS gives an advantageous effect.

It is known that the ability of hydrophilic SAS to kill an insect can decrease if the hydrophilic SAS is wetted, for example if the humidity is high. In contrast, the ability of hydrophobic SAS to kill an insect is not affected if the hydrophobic SAS is applied to a wetted environment. Therefore, there are advantages to the application of at least some hydrophobic SAS. However, hydrophobic SAS is more expensive and complex to produce; therefore, costs can be reduced by applying at least some hydrophilic SAS.

In addition to the economic and environmental advantages to be gained from mixtures of hydrophilic SAS and hydrophobic SAS, the combination of hydrophilic SAS and hydrophobic SAS gives a synergistic effect on the rate of killing of insects when compared to administration of each SAS alone.

The present invention has surprisingly found that a mixture of synthetic amorphous silica (SAS) can be used to control insects, including flying insects, on and around stored products or in structures.

According to a first aspect, the present invention provides a method of killing insects on or around stored products or in structures, comprising the step of:
i. depositing or suspending in the air a composition comprising a mixture of hydrophilic synthetic amorphous silica (SAS) and hydrophobic SAS on or around the stored products or structure.

Preferably, the mixture of hydrophilic synthetic amorphous silica and hydrophobic synthetic amorphous silica is used in a ratio of hydrophilic SAS to hydrophobic SAS of between 99.9:0.1 and 0.1:99.9. For example, the ratio may be between 99:1 and 1:99, 80:20 to 20:80, 75:25 to 25:75, 60:40 to 40:60. The ratio may be 99.9:0.1, 99:1, 80:20, 75:25, 60:40, 50:50, 0.1:99.9, 1:99, 20:80, 25:75, or 40:60. The ratio of hydrophilic to hydrophobic SAS suitable for application depends on the moisture content of the surface and the relative humidity of the air at the time of application.

The synthetic amorphous silica is preferably surface modified for different application purposes. The SAS of the present invention is a mixture of hydrophilic SAS and hydrophobic SAS. The hydrophobic SAS may be produced by treating hydrophilic SAS to generate hydrophobic SAS. For example, one method of producing hydrophobic SAS is by coating hydrophilic SAS (e.g. HP8) with an oil such as silicon oil, to produce a hydrophobic SAS (e.g. HB9) (Table 1). If oil is used to coat the SAS particle to produce hydrophobic SAS, the oil is preferably chosen from the list comprising: silicon oil, vegetable oil, canola oil, olive oil. Preferably the oil used to coat the SAS particle to produce hydrophobic SAS is a food grade product, so that the hydrophobic SAS can be applied to food products.

The methods of the present invention can be used to control a range of insects. For the purposes of the present invention the term “insect(s)” is taken to include related pests such as arachnids, including mites and spiders. Similarly, the term “insecticide” extends to agents that are active against these other pests that are not strictly insects.

The insect may be a beetle belonging to the order Coleoptera. In this case, the insect more preferably belongs to the suborder Polyphaga. Even more preferably, the insect belongs to a family selected from the list of families comprising: Terebrionidae; Bostrichidae; Curculionidae; Laemophloeidae; Anobiidae and Silvanidae. In one particular form of the invention, the insect belongs to a genus selected from: Tribolium, Rhyzopertha, Sitophilus, Lasioderma, Oryzaephilus, Trogoderma, Psocoptera, Bruchus, Oryzaephilus, Blatta, Periplaneta and Cryptolestes.

The insect may be a psocid belonging to the order Psocoptera, that is booklice, barklice or barkfly. The insect may be a silverfish of the order Zygentoma.

The insect may be a butterfly or moth belonging to the order Lepidoptera. In this case, the insect more preferably belongs to the suborder Gelechiidae, Tineidae, Galleriidae, Phycitidae and Pyralidae. Even more preferably, the insect belongs to a family selected from the list of families comprising: Sitotroga, Tinae, Aphomia, Plodia, Ephestia and Pyralis. In one particular form of the invention, the insect belongs to a genus selected from the list of genera comprising: Sitotroga (for example Sitotroga cerealella), Tinae (for example Tinae tugurialis), Aphomia (for example Aphomia gularis), Plodia (for example Plodia interpunctella), Ephestia (for example Ephestia cautella), Pyralis (for example Pyralis pictalis) and Aglossa (for example Aglossa dimidiate).

The insect may be a cockroach or a termite of the order Blattodea. In the case of cockroaches, the insect pest is preferably chosen from: German cockroach Blatella germanica, American cockroach Periplaneta americana, Australian cockroach Periplaneta australasiae, Smokybrown cockroach Periplaneta fuliginosa, Brownbanded cockroach Supella longipalpa or Oriental cockroach Blatta orientalis. In the case of termites, the insect pest is preferably chosen from: Subterranean termite Coptotermes acinaciformis, Coptotermes frenchi, Coptotermes lacteus, Giant northern termite Mastotermes darwiniensis, Cryptotermes genus, West Indian drywood termite Cryptotermes brevis, Heterotermes ferox, Schedorhinotermes intermedius, Nasutitermes fumigatus, or Nasutitermes walker.

The insect may be an ant of the order Hymenoptera, family Formicidae.

The present method for killing insects is for the killing of insect pests in stored products. The stored products may include post-harvest crops (grain, seed, pulse, etc) or processed foods (flour, packaged seed or grain etc). The stored products to which the insecticide mixture of the present invention is applied may be varied and includes a food selected from the group comprising: grain such as wheat, barley, oats, pulse; oilseeds such as canola, safflower and peanut; processed foods such as polished rice, brown rice and pet food; nuts; and dried fruit.

The stored products may be housed in a silo or some other bulk storage device or facility such a bunker or warehouse. Alternatively, the stored products may be housed in a domestic environment such as the pantry of a home. The stored products may be loose (for example a silo containing loose piles of wheat) or may be bagged or otherwise packaged (for example bags of flour, packages of pet food, or boxes of dried fruit).

The present method for killing insects is also for the killing of insect pests in and on structures such as houses, commercial buildings and bridges. For example, the method may be used to treat or prevent infestations of termites, ants, moths etc in buildings, or damage to bridges or other structures by termites and ants.

The insects may be flying insects. This refers to insects that in their adult form use flight to move from place to place. The method of the present invention will work if it contacts such flying insects while in flight but will also work to kill flying insects once either the SAS or the insect has settled on a surface such as food or a structural surface.

By the term “pest” it is meant that the insect causes damage to food to reduce its economic value or edibility or damages structures by eating the structure itself (usually structural timbers) or eating electrical wiring and other elements of the structure.

The silica can be blown or otherwise circulated in the air to cover a desired area. For example, the SAS may be blown from a blower as dust, applied over the food or structural surface; sprinkled from a packet over food or structural surface; mixed into food; suspended in the air around food or structural surface; or applied to surfaces around food to prevent the insects encountering the food.

The silica may be aerated. When the silica is aerated it may be suspended in a carrier fluid or gas, such as air, nitrogen, carbon dioxide or fumigant gas.

Preferably the SAS is suspended in the air around stored products or a structural surface at a rate of between 0.1-20 g/cm³, 0.25-15 g/cm³ or 0.5-10 g/cm³. The SAS may be applied at a rate of at least 0.1 g/cm³, 0.2 g/cm³, 0.3 g/cm³, 0.4 g/cm³, 0.5 g/cm³, 0.6 g/cm³, 0.7 g/cm³, 0.8 g/cm³, 0.9 g/cm³, 1 g/cm³, 2 g/cm³, 3 g/cm³, 4 g/cm³, 5 g/cm³, 6 g/cm³, 7 g/cm³, 8 g/cm³, 9 g/cm³, or 10 g/cm³. Preferably the SAS is applied at between 0.5-10 g/cm³.

Preferably the SAS is deposited on a surface such as stored products or the surfaces around stored products or a structural surface at a rate of between 0.1-5 g/cm², 0.5-3 g/cm², or 1-2 g/cm². The SAS may be applied at a rate of at least 0.1 g/cm², 0.2 g/cm², 0.3 g/cm², 0.4 g/cm², 0.5 g/cm², 0.6 g/cm², 0.7 g/cm², 0.8 g/cm², 0.9 g/cm², 1 g/cm², 1.5 g/cm², 2 g/cm², 2.5 g/cm², 3 g/cm², 3.5 g/cm², 4 g/cm², 4.5 g/cm², or 5 g/cm². Preferably the SAS is applied at between 1-2 g/cm².

Preferably the SAS is mixed with stored products at a rate of between 25-500 mg/kg, 50-400 mg/kg, 75-300 mg/kg, 100-250 mg/kg of food. The SAS may be applied at a rate of at least 25 mg/kg, 50 mg/kg, 75 mg/kg, 100 mg/kg, 125 mg/kg, 150 mg/kg, 175 mg/kg, 200 mg/kg, 250 mg/kg, 300 mg/kg, 350 mg/kg, 400 mg/kg, 450 mg/kg or 500 mg/kg of food. Preferably the SAS is applied at between 100-200 mg/kg of food.

For the purposes of the present invention the term “synthetic” means non-naturally occurring amorphous silica. The synthetic amorphous silica of the present invention excludes naturally occurring amorphous silica such as diatomaceous earth. The synthetic amorphous silica (SAS) may be produced by standard thermal route (pyrogenic/fumed) or wet route (precipitated, gel, colloidal) processes.

Preferably, the synthetic amorphous silica comprises a solid such as a particulate solid. The synthetic amorphous silica may comprise a dust or powder.

By “amorphous” it is meant that the SAS is a solid that lacks the long-range order that is characteristic of a crystal. Amorphous silica is non-crystalline silica that does not contain quartz glass or fused quartz. The lack of crystalline silica reduces the danger of inhaled silica causing silicosis.

It is preferred that the SAS of the present invention comprises less than 0.5%, 0.4%, 0.3%, 0.2% or 0.1% crystalline silica, more preferably less than 0.09%, 0.08%, 0.07%, 0.06%, 0.05%, 0.04%, 0.03%, 0.02% or 0.01% crystalline silica.

The present invention provides a method of killing insects on or around stored products or in structures, comprising the step of:
i. depositing or suspending in the air a composition comprising a mixture of hydrophilic synthetic amorphous silica (SAS) and hydrophobic SAS on or around the stored products or structure.

Preferably, the synthetic amorphous silica comprises at least 91%, 92%, 93%, 94%, 95%, 96%, 97%, 98% or 99% silica, by weight.

Preferably, the synthetic amorphous silica is “food grade” insofar as it is suitable for consumption without undue adverse effects. Even more preferably, the synthetic amorphous silica meets the food grade certifications from at least one of the following regulatory bodies: Food Chemical Codex (FCC), US Food and Drugs Administration (USFDA), Australian Inventory of Chemical Substances (AICS), Canadian Food Inspection Agency (CFIA). Alternatively, or in addition, the synthetic amorphous silica may be on at least one of the following inventories: European Inventory of Existing Commercial chemical Substances (EINECS), Japan ENCS Inventory and the USA TSCA Chemical Substance Inventory.

Preferably, the composition used in the methods of the present invention contains less than 1% of contaminants from the list comprising: alumina, iron oxide, unreacted sodium silicate, aluminium salt or ammonium fluosilicate. Preferably, the composition contains no contaminants from the list comprising: alumina, iron oxide, unreacted sodium silicate, aluminium salt or ammonium fluosilicate

Preferably, the synthetic amorphous silica is the only insecticide in the composition.

The synthetic amorphous silica may comprise between 70-99.9% of the composition. For example, the SAS may comprise between 70-99.9%, 80-99.9%, 90-99.9%, or 70-90%, or 80-90% of the composition. The SAS may comprise at least 70%, 75%, 80%, 85%, 90%, 95% or 99% of the composition.

The composition may comprise active food safe compounds other than one or more active compounds of the invention.

The composition may further comprise one or more of the following auxiliary components: inert carrier(s), surface active agent(s) such as a sticker or spreader, stabilizer(s) and/or dye(s). The compositions may also be suspended in a carrier fluid, such as air, nitrogen, carbon dioxide or fumigant gas. The compositions preferably comprise auxiliaries such as extenders, solvents, spontaneity promoters, carriers, emulsifiers, dispersants, frost protectants, biocides, thickeners and/or other auxiliaries, such as adjuvants, for example. An adjuvant in this context is a component which enhances the biological effect of the composition, without the component itself having a biological effect. Examples of adjuvants are agents which promote the retention, spreading, attachment to the food surface, or penetration of the SAS into the insect. The active compounds may be combined with any solid or liquid additive commonly used for formulation purposes.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic or pseudoplastic thickeners), in-container microbial growth (antimicrobials), product freezing (antifreezes), colour (dyes/pigment dispersions), wash-off (film formers or sticking agents), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes.

The components other than the SAS (e.g. auxiliary components, other active agents, carrier fluids) may comprise less than 30% of the compositions of the present invention. The components other than the SAS may compromise 29%, 25%, 20%, 15%, 10%, 5%, 2.5%, 1% or 0.1% of the composition.

The compositions of the present invention are produced in a known manner, for example by mixing the active compounds with auxiliaries such as extenders, solvents and/or solid carriers and/or further auxiliaries, such as surfactants. The compositions are prepared either in suitable manufacturing plants or else before or during the application.

Preferably, the synthetic amorphous silica has an average particle size of less than 20000 nm, more preferably less than 10000 nm and even more preferably less than 1000 nm. It is particularly preferred for the synthetic amorphous silica to have an average particle size of less than 750, 500 or 250 nm. In one form of the invention the average particle of the synthetic amorphous silica is 50-200 nm, 100-150 nm or 110-120 nm. Preferably the average particle of the synthetic amorphous silica is between 50-200 nm.

Preferably, the synthetic amorphous silica has an effective surface area of at least 50 m²/g, 75 m²/g, 100 m²/g, 110 m²/g, 125 m²/g or 150 m²/g. In one form of the invention the synthetic amorphous silica has an effective surface area of 185-280 m²/g.

Preferably, the effective surface area according to the present invention is determined according to the BET technique.

Preferably, the synthetic amorphous silica has an oil absorption value of at least at least 50 ml/100 g, 75 ml/100 g, 100 ml/100 g, 125 ml/100 g, 150 ml/100 g, 175 ml/100 g, 200 ml/100 g or 250 ml/100 g. In one form of the invention the synthetic amorphous silica has an oil absorption value of 290-320 ml/100 g.

Preferably, the synthetic amorphous silica is adapted to generate a net negative charge on a substance to which it is applied. Preferably, the net negative charge is between −0.003 and −0.1. In one form of the invention the net negative charge is at least −0.09, −0.08, −0.07, −0.05, −0.025 or −0.01.

The methods of the present invention can kill insects by introducing the SAS onto the insect as it flies through the air, by introducing the SAS onto the insect as it crawls on the food or in structures, or by the insect coming into contact with SAS deposited on the food or structure, suspended in the air, or on surfaces surrounding the food or structure.

The methods of the present invention may be used to kill insects on stored products including post-harvest crops (grain, seed, pulse, etc) or processed foods (flour, packaged seed or grain etc). The stored products may be housed in a silo or some other bulk storage device or housed in a domestic environment. The stored products may be loose or may be bagged or otherwise packaged.

The present method for killing insects is also for the killing of insect pests in and on structures such as houses, commercial buildings and bridges.

The methods of the present invention can be used to control a range of insects. For example, the methods of the present invention may be used to kill insects of the orders Coleoptera, Psocoptera, Zygentoma, Lepidoptera, Blattodea and/or Hymenoptera.

The methods of the present invention may be used to kill insects in their larval stage, pupal (nymph) stage or adult stage.

### Compositions for Killing Insects

In another aspect, the present invention provides a composition for use in a method of killing insects on or around stored products or in structures, wherein the composition comprises a mixture of hydrophilic synthetic amorphous silica (SAS) and hydrophobic SAS and wherein the composition is deposited or suspended in the air on or around the stored products or structure.

Preferably, the synthetic amorphous silica is the only insecticide in the composition.

The compositions may comprise one or more of the following components: inert carrier(s), surface active agent(s) such as a sticker or spreader, stabilizer(s) and/or dye(s). The compositions may also be suspended in a carrier fluid, such as air, nitrogen, carbon dioxide or fumigant gas. The synthetic amorphous silica is preferably surface modified for different application purposes.

Preferably, the mixture of hydrophilic synthetic amorphous silica and hydrophobic synthetic amorphous silica is used in a ratio of hydrophilic SAS to hydrophobic SAS of between 99.9:0.1 and 0.1:99.9. For example, the ratio may be between 99:1 and 1:99, 80:20 to 20:80, 75:25 to 25:75, 60:40 to 40:60. The ratio may be 99.9:0.1, 99:1, 80:20, 75:25, 60:40, 50:50, 0.1:99.9, 1:99, 20:80, 25:75, or 40:60.

The synthetic amorphous silica may comprise at least 70%-99.9% of the composition. It is preferred that the SAS of the present invention comprises less than 0.5%, 0.4%, 0.3%, 0.2% or 0.1% crystalline silica.

Preferably the SAS is suspended in the air around stored products or a structural surface at a rate of between 0.1-20 g/cm³, 0.25-15 g/cm³ or 0.5-10 g/cm³. Preferably the SAS is deposited on a surface such as stored products or the surfaces around stored products or a structural surface at a rate of between 0.1-5 g/cm², 0.5-3 g/cm², or 1-2 g/cm². Preferably the SAS is mixed with stored products at a rate of between 25-500 mg/kg, 50-400 mg/kg, 75-300 mg/kg, 100-250 mg/kg of food.

Preferably, the synthetic amorphous silica has an average particle size of less than 20000 nm, more preferably less than 10000 nm and even more preferably less than 1000 nm. Preferably, the synthetic amorphous silica has an effective surface area of at least 50 m²/g, 75 m²/g, 100 m²/g, 110 m²/g, 125 m²/g or 150 m²/g. Preferably, the synthetic amorphous silica has an oil absorption value of at least at least 50 ml/100 g. Preferably, the synthetic amorphous silica is adapted to generate a net negative charge on a substance to which it is applied of between −0.003 and −0.1.

### Kits

In another aspect, the present invention provides a kit for killing insects on or around stored products or in structures, wherein the kit comprises:
ii. a mixture of hydrophilic synthetic amorphous silica (SAS) and hydrophobic SAS; and
iii. instructions for use
   wherein the composition is deposited or suspended in the air on or around the stored products or structure. The kit comprises the composition as described above and is used in a method as described above.

### General

Those skilled in the art will appreciate that the invention described herein is susceptible to variations and modifications other than those specifically described. The invention includes all such variation and modifications. The invention also includes all of the steps, features, compositions and compounds referred to or indicated in the specification, individually or collectively and any and all combinations or any two or more of the steps or features.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

Any manufacturer's instructions, descriptions, product specifications, and product sheets for any products mentioned herein or in any document incorporated by reference herein, are hereby incorporated herein by reference, and may be employed in the practice of the invention.

The present invention is not to be limited in scope by any of the specific embodiments described herein. These embodiments are intended for the purpose of exemplification only. Functionally equivalent products, compositions and methods are clearly within the scope of the invention as described herein.

The invention described herein may include one or more range of values (eg. Size, displacement and field strength etc). A range of values will be understood to include all values within the range, including the values defining the range, and values adjacent to the range which lead to the same or substantially the same outcome as the values immediately adjacent to that value which defines the boundary to the range. Accordingly, unless indicated to the contrary, the numerical parameters set forth in the specification and claims are approximations that may vary depending upon the desired properties sought to be obtained by the present invention. Hence “about 80%” means “about 80%” and also “80%”. At the very least, each numerical parameter should be construed in light of the number of significant digits and ordinary rounding approaches.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs. The term “active agent” may mean one active agent or may encompass two or more active agents.

The following examples serve to more fully describe the manner of using the above-described invention, as well as to set forth the best modes contemplated for carrying out various aspects of the invention. It is understood that these methods in no way serve to limit the true scope of this invention, but rather are presented for illustrative purposes.

### EXAMPLES

Further features of the present invention are more fully described in the following non-limiting Examples. This description is included solely for the purposes of exemplifying the present invention. It should not be understood as a restriction on the broad description of the invention as set out above.

### Example 1—Generation of Synthetic Amorphous Silicas (SAS) Powder

### Materials/Methods

### SAS Products

Basic reference (source) details of the dusts used in the examples are summarised in Table 1.

TABLE 1
Basic reference and source details of SAS products

| SAS | SAS | | |
|---|---|---|---|
| Iden- | prod- | | |
| tifier | ucts | Made from | Processing methods |
| HP4^{#} | Pirosil | sodium silicate (water glass) | Wet synthesis * |
| | PS 200 | | |
| HP7 | BT-30 | sodium silicate (water glass) | Wet/thermal synthesis |
| | | | ** |
| HP8 | BT-40A | sodium silicate (water glass) | Wet/thermal synthesis |
| HB9^{##} | BT-386 | sodium silicate (water glass) | Wet/thermal synthesis |
| | | | and surface modified |

^{#}Hydrophilic (HP)
^{##}Hydrophobic (HB)
* Wet method includes precipitated and/or aerogel method
** Thermal method includes thermal and/or pyrogenic and/or fumed methods

### Methods

To better characterise each SAS powder, the electrostatic charges were neutralised using a static gun (Proscitech) and then each SAS powder was adsorbed to sticky carbon tape and photographed using a scanning electron microscope (Phillips XL 20, Eindhoven, Netherlands) at scales of 1 um, 500 nm and 20 nm.

From the 1 μm micrograph 4 particle spots were randomly selected and measured for length and breadth. Same or similar spots were measured using the 500 nm micrograph. The measurements were converted to nm units using the scale at the base of electron micrograph and means and standard deviations were calculated. Each SAS powder product was analysed in duplicate.

### Results

The SAS powders in Table 1 were characterised according to a range of parameters (see Table 2).

TABLE 2
SAS powder characteristics

| SAS | | | | | |
|---|---|---|---|---|---|
| Iden- | Particle | BET surface | DBP absorption | Food | Hydrophilic/ |
| tifier | Size (nm) | area* (m²/g) | (ml/100 g dust) | grade | phobic |
| HP4 | <114.2 | 185 | 290 | Yes | Hydrophilic |
| HP7 | <116.4 | 260-280 | 310 | Yes | Hydrophilic |
| HP8 | <117.8 | ≥260 | 320 | Yes | Hydrophilic |
| HB9 | <116.8 | 260-280 | 300 | No | Hydrophobic |

*Named after the authors of the theory Brunauer, Emmett and Teller. BET is a widely used technique for the calculation of effective surface area using adsorption and to explain the physical adsorption of gas on solid surface

### Example 2—Efficacy of Formulations Against Ants and Termites using Primary Surface Treatment

### Materials/Methods

### SAS Powder

Five SAS formulations, HP4:HB9 (90 to 10), HP7:HB9 (50 to 50), HP8:HB9 (99.9 to 0.1) and HB9:HP8 (99.9 to 0.1), were tested for efficacy.

### Insects

Five species of ants and one species of termites were tested:
Bulldog ant Mmyrmecia pyriformis
Garden ant Lasius niger,
Pavement ant Tetramorium caespitum,
Singapore ant Monomorium destructor
Green-headed ant Rhytidoponera metallica
Subterranean termites, Coptotermes sp.

All the ant species were freshly collected from South Street campus, Murdoch University, WA. Subterranean termites, Coptotermes sp. were collected from South Perth, WA. The collected bulldog ants were stored in 150 mL glass jars with each jar containing 10 ants. The other 3 species of ants were stored separately in three different 250 mL glass jars with some food. Termites were stored in 20 L storage containers with timber from the termite nest. The bulldog ants were treated after 1 hour of collection, while the other 3 species of ants were tested within 48 hours. All insects collected were kept and tested under constant room temperature, 25° C. and 65% relative humidity.

### Chamber for Treatment

Twelve cm glass petri dishes were used for bulldog ants and for other ants and termites.

### Methodology

For bulldog ants M. pyriformis, the treatments involved introducing 10 adult bulldog ants onto a petri dish. All four SAS formulations were used at two application rates: 1 g/m² and 4 g/m². For the control, 10 active ants were added to a clean petri dish without dust. For each dosage, three replicates were prepared. Ants were exposed for periods of 10 mins and 30 mins. The number of dead insects was recorded.

For pavement, garden, Singapore, green-headed ants and subterranean termites, the treatments comprised 25 active ants or termites each in five petri dishes. All four SAS formulations were used at two application rates: 0.5 g/m² and 1.0 g/m². For the control, 25 active ants or termites were added to five clean petri dishes without dust. For each species, three repetitions were tested. After exposure to dust for 10 mins, 15 treated ants and termites were transferred to clean petri dishes and mortality was assessed at 0.5, 1, 2, 4 and 6 hrs. The remaining 10 ants or termites were used for the transfer effect experiment of Example 4.

### Results

In the bulldog ant (Mmyrmecia pyriformis) bioassay, all four SAS formulations provided complete control (100% mortality) of bulldog ants after 30 minutes exposure as compared to control where 0% mortality was observed (Table 3). All four SAS formulations had an effect on tested ants after 10 minutes exposure, but the results varied from 0-10% and 30-63% efficacy at 1 g/m² and 4 g/m², respectively. The variations of efficacy were related to the rate of HB9 (Hydrophobic SAS): the higher the ratio of HB9, the higher efficacy of killing.

TABLE 3
Mortality (%) of Bulldog ants treated with four SAS formulations

| | |
|---|---|
| 10 min | 30 min |

| SAS | | 1 g/m² | 4 g/m² | 1 g/m² | 4 g/m² |
|---|---|---|---|---|---|
| HP4:HB9 | 1 | 0 | 35 | 100 | 100 |
| (90 to 10) | 2 | 1 | 40 | 100 | 100 |
| | 3 | 0 | 35 | 100 | 100 |
| HP7:HB9 | 1 | 2 | 57 | 100 | 100 |
| (50 to 50) | 2 | 4 | 45 | 100 | 100 |
| | 3 | 1 | 52 | 100 | 100 |
| HP8:HB9 | 1 | 0 | 30 | 100 | 100 |
| (99.9 to 0.1) | 2 | 0 | 31 | 100 | 100 |
| | 3 | 0 | 29 | 100 | 100 |
| HB9:HP8 | 1 | 5 | 61 | 100 | 100 |
| (99.9 to 0.1) | 2 | 10 | 60 | 100 | 100 |
| | 3 | 8 | 63 | 100 | 100 |
| Control | 1 | 0 | 0 | 0 | 0 |
| | 2 | 0 | 0 | 0 | 0 |
| | 3 | 0 | 0 | 0 | 0 |

HP. Hydrophilic
HB. Hydrophobic

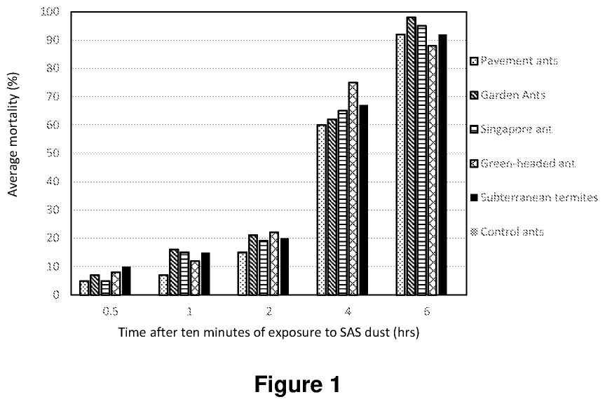

In the pavement, garden, Singapore, green-headed ants and subterranean termites bioassay, mortality rates between 88 to 98% were observed (depending on the type of ants) at 6 hours when the insects were moved to a clean petri dish after exposing them to the dose rate of 0.5 g/m² (FIG. 1) for 10 min. Mortality rates of 5 to 20% were observed for the first two hours, but underwent a strong increase after 3 to 4 hours exposure, rising to 60-75% (FIG. 1).

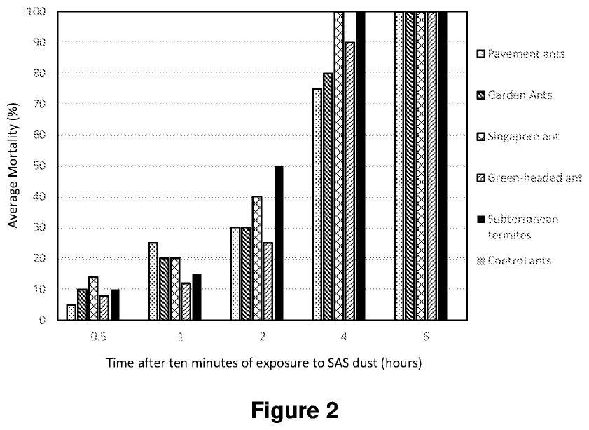

The SAS formulations HP8:HB9 (99.9 to 0.1) led to complete (100%) mortality for Singapore ants and subterranean termites after 4 hr when exposed for 10 mins to 1.0 g/m² then moved to a clean petri dish (FIG. 2). Complete (100%) mortality was achieved in garden ants, pavement ants and green-headed ants at 6 hours when moved to clean petri dish after exposing them to the dose rate of 1.0 g/m² for 10 mins (FIG. 2).

### Example 4—Efficacy of Dusts Against Ants and Termites in Transfer Effect

### Materials/Methods

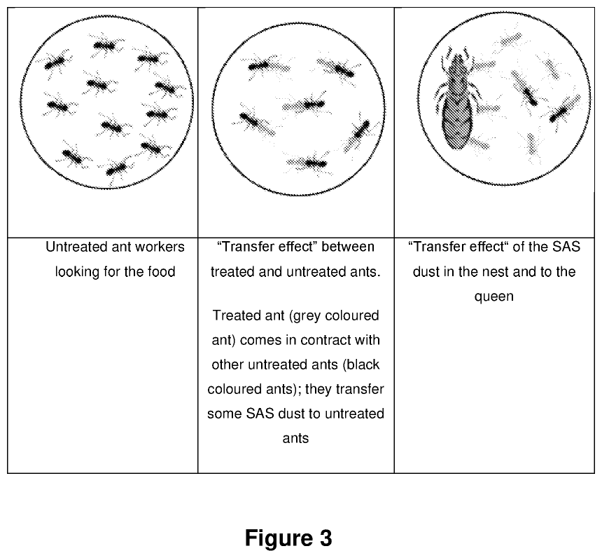

A transfer effect experiment was carried out to evaluate the efficiency of SAS formulations on ants and termites. Ants and termites are social insects, which show frequent contacts with each other either with antennae or mouthparts. The process of transfer is shown in FIG. 3.

Experiments were undertaken on two species of insects: pavement ant (T. caespitum) and subterranean termites (C. acinaciformis).

Two sets of ten petri dishes were set out, containing between one and ten pavement ants or subterranean termites. For one set of petri dishes, the ants or termites were treated with HP8:HB9 (99.9 to 0.1) at a dosage of 1.0 g/m². The ants or termites in the second set of ten petri dishes were used as untreated controls. Two sets of replicates were prepared for each treatment and control. Five non-treated ants or termites were released into each of the petri dishes containing 1 to 10 treated ants or termites. The same procedure was followed for the control petri dishes. The number of dead insects was recorded at a regular interval.

### Results

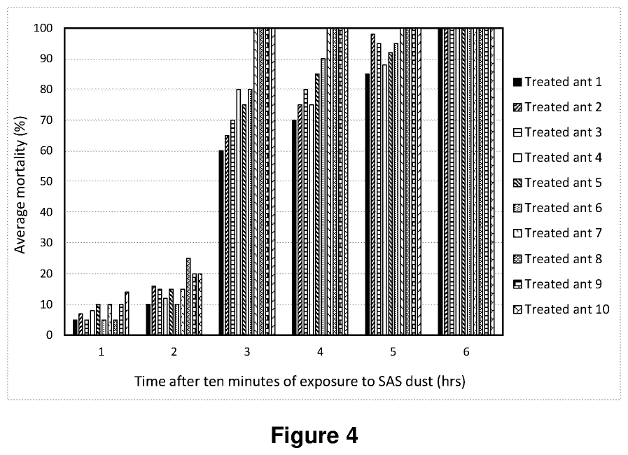

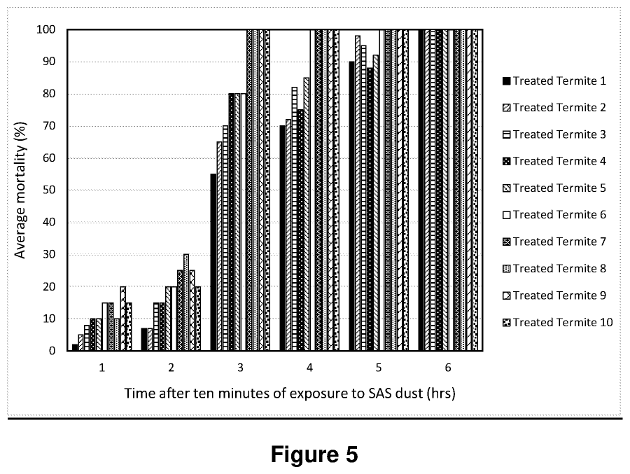

In general, the presence of a single treated pavement ant was sufficient to provide 100% mortality of the five untreated ants after 6 hours continuous exposure (FIG. 4). Exposure to up to four treated ants did not change the time required to achieve 100% mortality. However, exposure to five or more treated ants decreased the time required to achieve 100% mortality, with the best results recorded for the five untreated ants exposed to seven treated ants' treatments achieving 100% mortality in 3 hours exposure time. Similar results were obtained for termites (FIG. 5).

### Example 5—Effect of Humidity and Ratio of Hydrophilic to Hydrophobic SAS on Killing of Stored Grain Pests

### Materials/Methods

The same methodology as for Example 2 was used to treat red flour beetle Tribolium castaneum. However, the relative humidity of the air inside the application chamber was modified in a range between 10% and 95% relative humidity.

Ratios of HP8 to HB9 of between 99.9:0.1 and 0.1:99.9 were tested. As HP8 is hydrophilic and HB9 is hydrophobic, relative humidity will have different effects depending on the relative amount of each SAS powder.

The treatments comprised 20 active Tribolium castaneum, petri dishes containing 2.0 g/m² formulations, respectively. After exposure to dust for 10 mins, the treated insects were transferred to clean petri dishes and mortality was assessed at 2, 4 and 6 hrs.

### Results

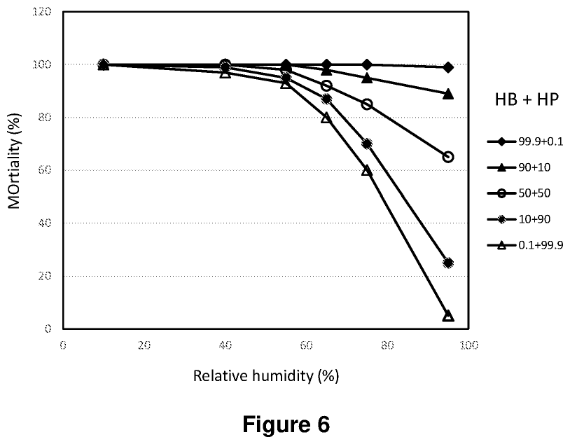

Results are shown in FIG. 6. Hydrophilic SAS (HP8) absorbs moisture when the relative environmental humidity is increased, leading to a reduce mortality or efficacy for insect killing. Relative environmental humidity has no effect on the ability of hydrophobic SAS (HB9) to kill insects.

When HB9:HP8 was 99.9:0.1, 90:10, 50:50 10:90 and 0.1:99.9, the Tribolium castaneum mortality of was 100%, 90%, 65%, 25% and 5% at 95% relative humidity. Thus, when there is a predominance of hydrophilic HP8 in the composition, Tribolium castaneum mortality is reduced in humid conditions, but if there is a predominance of hydrophobic HB9 in the composition, the Tribolium castaneum mortality remains high.

### Example 6—Effect of Ratio of Hydrophilic to Hydrophobic SAS on Killing of Stored Grain Pests

### Materials/Methods

The treatments comprised 50 active Tribolium castaneum in a 100 mL glass jar containing 50 g wheat with a moisture content of 11.3%. 5 mg of SAS formulation was added to achieve 100 mg/kg formulation/wheat. The beetles were stored at 25° C. and 60-70% relative humidity. The mortality of the Tribolium castaneum was assessed after 2, 3, 5 and 7 days.

Ratios of HP8 to HB9 of between 99.9:0.1 and 0.1:99.9 were tested. As HP8 is hydrophilic and HB9 is hydrophobic, relative humidity will have different effects depending on the relative amount of each SAS powder.

Combined toxicity was calculated by the formula of synergistic ratios (SRs) using following Equation (Plackett and Hewlett, 1963 Quantal responses to mixture of poison. J. R. Stat. Soc B,14,41-163).

$$SR = \frac{Mortality ( \% ) of HP + HB ( mixture )}{Mortality ( \% ) of HP or HB alone} \\ Where : SR = 1 describes an additive action \\ SR < 1 describes an antagonism \\ SR > 1 describes a synergism$$

### Results

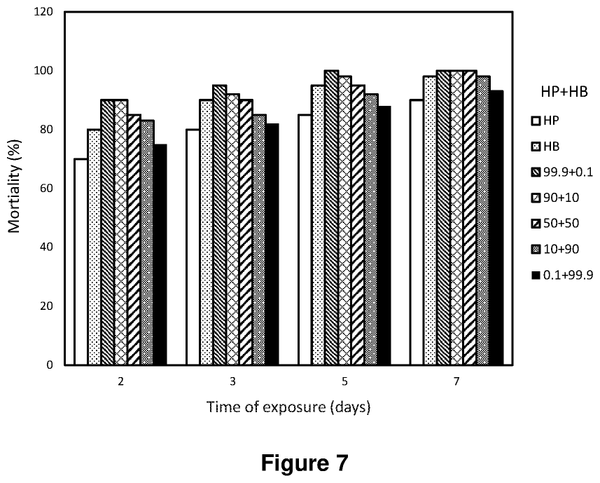

For all ratios of HP8 to HB9 of between 99.9:0.1 and 0.1:99.9, mortality increased with increasing period of exposure time (FIG. 7).

In a comparison of the efficacy of HP, HB and HP+HB for killing Tribolium castaneum in wheat grain at the dose rate of 100 mg(HP, HB and HP+HB)/kg of wheat, synergistic results were obtained for combinations of HP and HB (FIG. 7 and Tables 4 and 5).

In a comparison of the efficacy of HP compared to HP+HB for killing Tribolium castaneum in wheat grain at the dose rate of 100 mg(HP and HP+HB)/kg of wheat, synergistic results were obtained for combinations of HP and HB (SR>1) (FIG. 7 and Table 4).

In a comparison of the efficacy of HB and HP+HB for killing Tribolium castaneum in wheat grain at the dose rate of 100 mg(HB and HP+HB)/kg of wheat, synergistic results were obtained for combinations of HP and HB (SR>1) when HB was present at greater than 50%. However, if the HB ratio was less than 50%, HP and HB were an antagonistic (SR<1) (FIG. 7 and Table 5). This shows that HB plays an important role in the killing of Tribolium castaneum.

TABLE 4
Synergistic ratios (SRs) of HB + HP compared with HP alone

| 99.9 + 0.1 | 90 + 10 | 50 + 50 | 10 + 90 | 0.1 + 99.9 |
|---|---|---|---|---|
| 1.29 | 1.29 | 1.21 | 1.19 | 1.07 |
| 1.19 | 1.15 | 1.13 | 1.06 | 1.03 |
| 1.18 | 1.15 | 1.12 | 1.08 | 1.04 |
| 1.11 | 1.11 | 1.11 | 1.09 | 1.03 |

TABLE 5
Synergistic ratios (SRs) of HB + HP compared with HB alone

| 99.9 + 0.1 | 90 + 10 | 50 + 50 | 10 + 90 | 0.1 + 99.9 |
|---|---|---|---|---|
| 1.13 | 1.13 | 1.06 | 1.04 | 0.94 |
| 1.06 | 1.02 | 1.00 | 0.94 | 0.91 |
| 1.05 | 1.03 | 1.00 | 0.97 | 0.93 |
| 1.02 | 1.02 | 1.02 | 1.00 | 0.95 |

1. A method of killing insects on or around stored products or in structures, comprising the step of:
i. depositing or suspending in the air a composition comprising a mixture of hydrophilic synthetic amorphous silica (SAS) and hydrophobic SAS on or around the stored products or structure.

2. The method of claim 1 wherein the insect to be killed is able to fly in its adult form.

3. The method of claim 1 wherein the insect to be killed is a member of an Order chosen from the list comprising: Coleoptera, Psocoptera, Zygentoma, Lepidoptera, Blattodea and Hymenoptera.

4. The method of claim 1 wherein the SAS has one or more of the following features:
a) an average particle size of less than 20000 nm;
b) an effective surface area of at least 50 m²/g;
c) an oil absorption value of at least at least 50 ml/100 g; and/or
d) is adapted to generate a net negative charge on a substance to which it is applied of between −0.003 and −0.1

5. A composition for use in a method of killing insects on or around stored products or in structures, wherein the composition comprises a mixture of hydrophilic synthetic amorphous silica (SAS) and hydrophobic SAS and wherein the composition is deposited or suspended in the air on or around the stored products or structure.

6. A kit for killing insects on or around stored products or in structures, wherein the kit comprises:
i. a mixture of hydrophilic synthetic amorphous silica (SAS) and hydrophobic SAS; and
ii. instructions for use
wherein the composition is deposited or suspended in the air on or around the stored products or structure.
